(19) United States
(12) Patent Application Publication
(10) Pub. No.: US 2003/0070720 A1
(43) Pub. Date: Apr. 17, 2003

(54) Barrier tubing

(76) Inventors: Kevin Bergevin, Kingston (CA); Kenneth Earl Stevens, Kingston (CA)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/255,246

(22) Filed: Sep. 26, 2002

Related U.S. Application Data
(60) Provisional application No. 60/325,225, filed on Sep. 27, 2001.

(51) Int. Cl. F16L 9/14

(52) U.S. Cl. 138/143; 138/139

(57) ABSTRACT

Plastic tube fluid handling means provided in the form of one or more polymeric tubes embedded in foil laminate which includes metal and at least one polymer. The preferred polymers are polyolefins and polyamides. The metal provides barrier protection making the structure suitable for use in fuel lines, refrigerator hose, in-floor heating pipe, solar hot water heating systems and the like. The tubes are of a geometry which provides burst strength, so that the metal can be quite thin.

### CROSS REFERENCE TO RELATED APPLICATION

This application claims the benefit of U.S. Provisional Application No. 60/325,225, filed Sep. 27, 2001.

### FIELD OF THE INVENTION

The invention relates to plastic tube fluid handling means for use in fuel lines, refrigerator hose, in-floor heating pipe, solar hot water heating systems and the like. More particularly, this invention relates to such structures incorporating one or more polymeric tubes surrounded by laminated foils.

### BACKGROUND OF THE INVENTION

Among the challenges in making plastic fluid handling devices is the need for improved barrier properties. Among the highest demands for low permeability are fuel lines and refrigeration hose applications. In the former, legislation in many areas requires structures with lower permeability to volatiles in (motor) fuel relative to incumbents such as nylon 11 or 12 or these in combination with fluoropolymers such as polytetrafluoroethylene (PTFE) or polyvinylidene fluoride (PVDF). For the latter, there is a need to keep the refrigerant in and both water vapor or moisture and air out under working conditions of high pressure.

It has been recognized that metal layers will provide impermeability to polymeric tubes for use in subfloor heating and other applications. However, structures for obtaining good impermeability for practical use in these systems from the combination of metal and plastic or polyamide and aluminum are not available or are costly to produce. Some have suggested applying metal after assembling a structure, such as by sputtering. However, sputtering, while it may give a complete coating, does not provide the impermeability needed. Others wrap a layer of foil around a preformed tube, either longitudinally or helically. The foil can be lapped and folded over at the seam to provide a complete seal (EP A 0 024 220 and U.S. Pat. No. 4,370,186) or can be welded for example by means of a laser (U.S. Pat. No. 5,991,485). Usually, the foil is overcoated with additional layer(s) of plastic. Tubing made using these processes is costly, as the processes suffer from relatively low productivity.

U.S. Pat. No. 4,069,811 discloses in FIG. 7 a heat exchanger element with spaced-apart copper or plastic tubes surrounded by and encased in spot-welded sheets of a rigid, preferably black, metal absorber plate. U.S. Pat. No. 5,469,915 shows tubes of plastic or metal encased in and held apart by plastic sheets. European Patent Publication 864,823 A2, published Sep. 26, 1998, discloses tubes for solar heat exchangers made of an elastomer or plastic inner layer, a stiffener layer of thermally conductive metal such as aluminum in the form of a mesh or helical layer, and optionally an outer layer of the same elastomer or plastic. The inner polymer layer can be 0.1-2.5 mm (0.004-0.1 inches) thick, preferably 0.1-0.3 mm (0.004-0.012 inches), and the stiffener can be 0.1-2 mm (0.004-0.079 inches) thick. However, although the metal stiffener may absorb heat well, it is taught to be used as a mesh or helical layer, so it would not provide any degree of impermeability.

U.S. Pat. No. 3,648,768 shows making a web of plastic with parallel tubes spaced apart in the web. It says nothing about barrier layers or using metal in the webs.

### SUMMARY OF THE INVENTION

The invention provides a structure for use in fluid handling comprising at least one polymeric tube surrounded by and sealed to a laminated foil, said foil having two faces, one facing toward the tube, and the other facing away from the tube, said foil comprising at least one layer of metal with at least one polymer layer on at least the side facing the tube,

said tube having an inner diameter in the range of 5-50 mm in the case of one tube and 2-50 mm in the case of more than one tube, and a wall thickness in the range of 0.1-1.0 mm,

said foil having a total thickness in the range of 0.05-0.25 mm and a total metal thickness in the range of 0.002-0.1 mm.

### BRIEF DESCRIPTION OF THE DRAWING(S)

FIG. 1 is a perspective view of a multiple tube ribbon structure of the invention;

FIG. 2 is a perspective view of a single tube structure of the invention; and

FIG. 3 is a cross sectional view of an end of a typical structure of the invention.

### DETAILED DESCRIPTION OF THE INVENTION

Tubing and hose requirements for a number of industrial applications include very high barrier to water, or air/oxygen or contained materials such as refrigerants. For example, when attempting to design refrigerant hose from polymeric tubing, a number of factors must be considered:

i) The refrigerant must be retained inside the tubing structure for a long time such as for many years, with minimal losses.

ii) Moisture and air must be prevented from permeating into the tubing. Air is non-condensable and would diminish the performance of the refrigeration system. Moisture reacts with refrigerants such as hydrofluorocarbons (HFC's) and hydrochlorofluorocarbons (HCFC's) and the products of this reaction can lead to failure of the system due to corrosion and sludge.

iii) Many refrigerants operate under high pressures (several hundred psig) and the tubing must be capable of withstanding 3-5 times the normal system operating pressures.

Unfortunately, the best polymeric barrier materials available may at times be insufficient to keep moisture and air entry below an acceptable level.

Reference is made throughout the case to tubes (either singular as “tube” or plural as “tubes” or even both as “tube(s)”), “tubing” and the like. It is to be understood that depending on the application of interest one tube and/or a plurality of tubes may be selected in each such instance. Certain dimensional criteria are set forth for single tubes versus multiple tubes as well. Therefore throughout the case these terms are often used interchangeably, and it will be apparent to the reader whether the singular, plural or both apply.

Moreover, those having skill in the art to which the invention pertains will recognize that throughout the description of the present invention the terms “foil”, “laminated foil”, “film” and the like are intended to convey the same meaning.

In the design of fuel lines, legislation in many areas requires structures with lower permeability to volatiles in (motor) fuel relative to incumbents such as nylon 11 or 12 or these in combination with fluoropolymers such as PTFE or PVDF.

In the design of tubing for infloor heating systems, low permeability relative to oxygen is required to maintain anaerobic conditions inside the system to prevent corrosion of ferrous parts such as boilers. Likewise, low permeability to water vapor is necessary as water loss would require makeup with fresh, oxygen-rich water. Similar issues are faced in solar hot water heating systems.

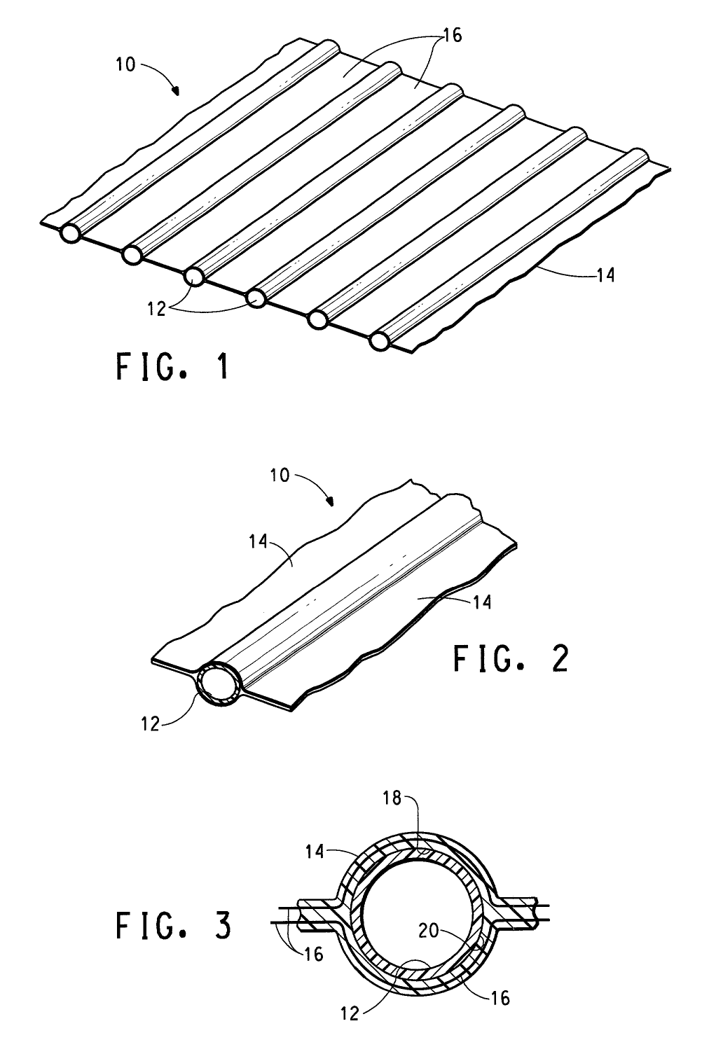

Having reference to FIGS. 1 and 2 herein, the present invention contemplates a composite structure depicted generally at 10. A polymeric tube 12 is completely surrounded by film 14 containing a metal layer 16.

As shown in FIG. 3 herein, the film 14 containing a metal layer 16 is wrapped in conformal fashion around the tube 12 in the array and is preferably bonded to the outer surface 18 of the tube 12 where it contacts the tube 12 or to itself in the areas adjacent to the tube(s) 12. It is desirable to produce a tight wrap around the tube 12, with no significant free volume between the outside surface 18 of the tube(s) 12 and the inside surface 20 of the film 14. The metal layer 16 provides a suitable barrier, capable of preventing excessive transmission of moisture, air, refrigerant or other permeants. Such foil laminates are widely available and are of relatively low cost, compared with other materials of similar barrier.

Furthermore, the location of the high barrier layer outside of, and surrounding the tubing 12, as shown in FIGS. 1, 2 and 3, serves to keep the tubing relatively dry. This is significant when the tubing is a moisture sensitive material such as a polyamide. The burst pressure of dry polyamide tubing is much higher than it is for polyamide exposed to environmental humidity. This feature allows the tubing to be designed with a larger tube diameter.

The combination of all of these features results in a relatively simple low cost material (a polyamide tube with outer bonding layer inside a foil laminate with inner bonding layer) which could be produced in a low cost process and which would be fully functional for a wide variety of high barrier tubing or hose applications. Referring once again to FIG. 3, corrosion of the metallic layer 16 can be minimized with the inclusion of a polymeric layer 22 outside of the metal layer, i.e. the metal layer 16 is sandwiched. Alternatively, for more corrosive applications, a more corrosion resistant metal such as nickel or tin may be used as the metallic layer 16. Aluminum here means the metal itself or various appropriate alloys based on aluminum. Two or more layers of foil can be used, and they may be made from a single sheet that has been folded, or from multiple sheets, with the plastic layers applied to each layer of metal or to the whole set of foil. Also, when a first layer of foil is applied to one side of a tube or set of tubes, and then a second layer is applied to the other side, the same piece of foil can be folded and used on both sides.

For some applications, it may be desirable for the film to be quite flexible, thereby enhancing the flexibility of the entire bonded structure.

Tubes can be circular in cross-section or can be elliptical or of other non-circular shape. The tubing may be extruded as elliptical in shape or may be extruded as circular in shape and then made elliptical in the process of making the structure.

A number of different polymers could be chosen for the tubing material, but selection depends on the needs for specific applications and should be based on: service temperature, chemical resistance and pressure.

Tube diameter and wall thickness are sized to handle the pressure of respective applications.

One may optionally co-extrude layers on the exterior of tubing, or add layers on one side of the film material to enhance bonding. It is important in some cases to bond the film layer to the tubing and to the opposing film layer in order to prevent “pocketing” of refrigerant or other permeants such as water or air between the tubing and the foil laminate.

Metal surrounds the tubing except in small areas at nodes and edges and this provides a significant improvement in barrier to permeation of refrigerant, moisture and air. Within the foil laminate, more than one layer of metal could be used or the metal layer thickness could be varied to achieve desired levels of barrier.

The approach used in Example 2 began when it was realized that the tubes could be “tacked” onto one of the film layers by applying heat and pressure. This process illustrates production of a number of barrier tubes in parallel; individual barrier tubes can be produced by slitting the film between the tubes, or by carrying out the process with a single tube. Though the tubes were only bonded to the film over a very narrow area, the bond was sufficient to hold the tubes in place long enough to allow the process to be completed. It was necessary to have some means to line up the tubing and this was accomplished by pulling the tubing through a block of PTFE which had slots in it. The slots expose part of the tube surface to the outside. By pulling the film and the aligned tubes, in contact, over a heat source, the tacking of the tubes to the film was achieved. The process was completed by sealing the edges of a second film to the first film and then evacuating all of the air which was between the tubes and the film, using a vacuum sealer. When the structure was then placed in an oven of suitable temperature, the final bonding together of all layers was completed using atmospheric pressure as the source of pressure.

The invention will become better understood upon having reference to the examples herein.

### EXAMPLES

### Example 1

Nylon 66 tubing 65 cm in length, having an inside diameter of 5.8 mm and a wall thickness of 0.6 mm, was encased in a laminated foil. The tubing contained a heat stabilizer additive, consisting of 0.6 percent of a 7-1-1 (by weight) blend of potassium iodide, cuprous iodide, and aluminum stearate. The laminated foil was obtained commercially from Ludlow Corporation as BFW-48 film. The BFW-48 film consists of (in order) approximately 0.038 mm (0.0015 inches) of LLDPE (linear low density polyethylene), 0.022 mm (0.00085 inches) of LDPE (low density polyethylene), 0.007 mm (0.00029 inches) of aluminum foil, 0.022 mm (0.00085 inches) of LDPE and 0.012 mm (0.00048 inches) of PET (polyethylene terephthalate), for a total thickness of approximately 0.10 mm (0.004 inches).

To make the barrier tubing, the BFW-48 film, having an approximate width of 8 cm and length of 80 cm, was first folded in halves along the length, such that the side with the LLDPE layer faces inward. The 4 cm wide folded film was then passed through a DOBOY “Hospital Sealer” (a continuous/rotary heat sealer), so as to create approximately 2.5 cm of sealed portion, inward of the unfolded edge. This resulted in the formation of a sleeve with an approximate opening diameter of 1.5 cm.

The 65 cm long nylon tubing was then inserted into the sleeve completely. Since the sleeve was longer than the tubing, there was an extra length of film covering at each end. Using the DOBOY sealer, one of these ends was heat sealed.

The encased tubing was then placed in an AUDIONVAC AE401 vacuum sealer chamber, such that the unsealed end of the sleeve was laid across the heat seal bar. The air inside the chamber was then evacuated, and a heat sealing process of the sleeve's open end proceeded. This resulted in the sleeve enclosing and conforming to the shape of the tubing, with no air in the structure. The vacuum-sealed sleeve was then placed in a Blue M oven (model OV-490A-3) and heated at 120° C. for 10 minutes. The heat melted the LLDPE layer on the film and allowed bonding to form, such that upon cooling, the tubing was tightly encased by the laminated foil. The excess edges around the tube was finally slit off to within about 3 mm from the edge. The excess film portion at the ends were also cut.

### Example 2

Tubing with an inside diameter of 2.9 mm (0.114 inches) and a wall thickness of 0.34 mm (0.0133 inches) was used to make a ribbon structure by bonding the tubing to two film layers. The tubing was a co-extruded structure in which the inner layer consisted of nylon 66 at 0.30 mm (0.0118 inches thick) and the outer layer consisted of an anhydride-modified low density polyethylene 0.04 mm (0.0015 inches) thick, available from E. I. DuPont de Nemours & Co. as Bynel® 4206. The melting point of the polymer in the outer layer was approximately 102° C., its melt index was 2.5 and its density was 0.92 g/cc. The purpose of the outer layer was to improve the bond between the tubing and the film in the finished structure. Eight tubes of the above composition were tacked to the polyethylene surface layer of BFW-48 film from Ludlow Corporation. The BFW-48 film consists of (in order) approximately 0.038 mm (0.0015 inches) of LLDPE (linear low density polyethylene), 0.022 mm (0.00085 inches) of LDPE (low density polyethylene), 0.007 mm (0.00029 inches) of aluminum foil, 0.022 mm (0.00085 inches) of LDPE and 0.012 mm (0.00048 inches) of PET (polyethylene terephthalate), for a total thickness of approximately 0.10 mm (0.004 inches).

The tubes were tacked to the film by pulling them through a slotted tube guide and then pressing them to the surface of the film. The tubes were spaced apart, i.e. one tube did not contact the adjacent tubes in the structure. The film was heated from underneath by a “Dataplate Digital Hot Plate” made by Cole-Parmer and its surface was maintained at a uniform temperature of about 125° C. A second layer of BFW-48 film was placed facing the first layer (which had the tubes attached), such that the two polyethylene surfaces of the film were facing each other. Each film was 127 mm (5 inches) wide. The film edges were then sealed together using a “DOBOY Hospital Sealer” (a continuous rotary heat sealer). Lengths of this sleeve were produced which were approximately 100 cm (3.3 feet long). Short lengths of tubing were peeled back and cut off at each end, in order to alow the next step to proceed.

The sleeves thus formed were then placed in an AUDIONVAC AE401 vacuum sealer. The air between the film layers and the tubes was evacuated and the ends of the sleeve were sealed. The vacuum-sealed sleeves were then placed in a Blue M oven (model OV-490A-3) and heated at 120° C. for 15 minutes. The heat melted the polyethylene layers and bonded the structure together. The outside excess edges of the ribbon were trimmed. Samples of the ribbon were tested as a refrigerant hose and also, other samples of the ribbon were slit into individual tubes and tested as a refrigerant hose.

What is claimed is:

1. A structure for use in fluid handling comprising at least one polymeric tube surrounded by and sealed to a laminated foil, said foil having two faces, one facing toward the tube, and the other facing away from the tube said foil comprising at least one layer of metal with at least one polymer layer on at least the side facing the tube,
said tube having an inner diameter in the range of 5-50 mm in the case of one tube and 2-50 mm in the case of more than one tube, and a wall thickness in the range of 0.1-1.0 mm,
said foil having a total thickness in the range of 0.05-0.25 mm and a total metal thickness in the range of 0.002-0.1 mm.

2. The structure of claim 1 wherein there are multiple tubes arranged in parallel, said tubes being held in place by, surrounded by and sealed to said laminated foil.

3. The structure of claim 1 wherein there is only one tube.

4. The structure of claim 1 wherein the inside diameter of the tube is from 8-12 mm.

5. The structure of claim 1 wherein said at least one tube further comprises a plurality of layers of polymer.

6. The structure of claim 1 wherein the polymer of at least the layer facing away from the tube in the foil is polyamide.

7. The structure of claim 5 wherein the polymer of the outer layer of the tube is bondable with the polymer layer of the foil facing the tube.

8. The structure of claim 7 wherein the polymer of at least one layer of the tube and at least one layer of the polymer of the foil are both polyamide.

9. The structure of claim 1 wherein the total thickness of foil is in the range of 0.07-0.2 mm and the total thickness of the metal layer(s) is in the range of 0.005-0.02 mm.

10. The structure of claim 9 where in the total thickness of the foil is in the range of 0.1-0.15 mm and the total thickness of the metal layer(s) is in the range of 0.005-0.01 mm.

11. The structure of claim 1 wherein the inner diameter of the tube is in the range of 8-12 mm and the wall thickness of the tubes is in the range of 0.1-0.25 mm.

12. The structure of claim 1 wherein the metal is aluminum.

13. The structure of claim 1 wherein the foil has a layer of polyolefin on the side facing the tube and a layer of polyamide on the side of the tubes facing away from the tube.

14. The structure of claim 1 wherein the foil has no layer of polymer on the side facing away from the tube.

15. The structure of claim 1 wherein there are multiple layers of polymer in the foil.

16. The structure of claim 1 wherein there are multiple layers of metal in the foil.

17. The structure of claim 1 wherein there are both multiple layers of polymer and multiple layers of metal in the foil.
